(19) United States
(12) Patent Application Publication
(10) Pub. No.: US 2014/0049942 A1
(43) Pub. Date: Feb. 20, 2014

(54) SOLAR POWERED LIGHT HAVING AN UNOBSTRUCTED LIGHT PATH

(71) Applicants: Robin Blake Kiran Chilton, London (GB); Sean Sun, Grand Cayman (KY); Xianyi Wu, Shenzhen (CN)

(72) Inventors: Robin Blake Kiran Chilton, London (GB); Sean Sun, Grand Cayman (KY); Xianyi Wu, Shenzhen (CN)

(21) Appl. No.: 13/590,109

(22) Filed: Aug. 20, 2012

(51) Int. Cl. F21L 4/00

(52) U.S. Cl. 362/96

(57) ABSTRACT

A portable solar powered light comprises a receptacle light shade with a hollow interior, and a lid with a first side and a second side, the first side including a rim to seal the hollow interior of the receptacle light shade, and the second side opposing the first side. The portable light further comprises a printed circuit board fitted in the lid including a light source to shine light into the receptacle light shade and electronic components configured to power the light source. The portable light further includes a solar panel embedded in the second side of the lid to power the electronic components. The portable light further comprises a drainage channel encased in the lid and configured to prevent contact of water with the electronic components. The drainage channel includes (i) a water inlet, (ii) a drainage conduit, and (iii) a water egress area.

### TECHNICAL FIELD

The disclosed embodiments relate to a solar powered light source with a receptacle light shade, the receptacle light shade providing an unobstructed light path for the light source.

### BACKGROUND

Several geographical locations (e.g., rural or commercially under-developed areas) situated away from electric power grids (such as established urban power grids) lack reliable and sustainable sources of electric power. Residents of these geographical areas need sustainable sources of light to perform their routine activities and to sustain their lifestyles. As such, there is a need for portable light sources that can be self-powered or powered using natural sources of energy (e.g., solar energy).

Portable light sources have been described in various patents. For example, U.S. Pat. No. 6,086,216 entitled “Bottle Lantern” describes a portable lighting device comprising a water bottle made of a light transmitting material, and a light bulb that transmits light into the water bottle via a light transmitting lens. Similarly, U.S. Pat. No. 6,179,437 entitled “Backpack Lantern” describes a light source attachment for use as a lantern comprising a non-opaque container into which a light source directs light via a light-diffusing light redirecting film. Further, the container described includes reflectors along its sides and bottom surface for focusing or intensifying the incident light.

While these portable light sources provide a viable alternative to electric power, they rely on complex optical components (such as optical lenses, light diffusing media such as redirecting films, and reflectors) for their operation. These complex optical components and arrangements increase the cost associated with the manufacture of the portable light sources and are readily susceptible to damage by external environmental factors (such as rain, humidity, air-borne particulate matter, weather, and temperature changes).

Accordingly, what is needed in the art are improved light sources that do not rely on a power grid, are cheaper to make, and are not readily damaged by the environment.

### SUMMARY

Disclosed are portable self-powered light sources that provide improved accessibility in impoverished rural and under-developed areas, and that are cheaper and more affordable than existing designs. The disclosed light sources address the need of reducing the cost associated with the manufacture of portable, self-powered light sources. Furthermore, the disclosed light sources address the need for improving the design of the light sources so as to increase their robustness to external environmental factors (e.g., water from rainfall and air-borne particulate matter).

In accordance with some embodiments, a portable solar powered light comprises a receptacle light shade. The receptacle light shade has a shape characterized by a frustum of a right circular cone, or similar shape, having a hollow interior with a closed end and an open end.

The portable solar powered light further includes a lid having first and second sides. The first side of the lid includes a rim that defines the boundary of an interior portion of the lid. The rim is configured to twistingly interlock (e.g., using mating sets of grooves or threads) with the open end of the receptacle light shade thereby sealing the hollow interior of receptacle light shade. The second side of the lid opposes the first side.

The portable solar powered light further includes a printed circuit board fitted within the interior portion of the lid. The printed circuit board includes two or more electronic components attached to a first side of the circuit board facing into the interior portion of the lid. The printed circuit board further includes a light source directly attached to a second side of the circuit board that opposes the first side of the circuit board. As such, the light source is proximal to the receptacle light shade and is configured to shine light into the receptacle light shade. The two or more electronic components are in electronic communication (e.g., electrically connected using traces and/or vias to allow a flow of electric current and charge) with the light source. The electronic components are configured to power the light source. In some embodiments, the light source is configured to directly couple light into the receptacle light shade and the receptacle light shade is formed of a homogenous light transmitting material. Accordingly, the receptacle light shade is directly illuminated by the light source (e.g., without the need for optical lenses, diffusing media and/or optical reflectors) and the receptacle light shade transmits the light to the surrounding, thereby acting as a distributed source of light.

The portable solar powered light further includes a solar panel embedded in the second side of the lid. The solar panel is in electronic communication (e.g., electrically connected) with the two or more electronic components thereby powering them. In some embodiments, the electronic components include one or more energy storage devices (e.g., one or more rechargeable batteries) configured to (i) store energy obtained from the solar panel or from an alternating current source and (ii) power one or more of the electronic components and the light source. Accordingly, the portable solar powered light source is configured to be self-powered or powered by natural solar energy without the need for electric power (e.g., obtained from AC mains).

The portable solar powered light further includes a drainage channel encased in the lid. The drainage channel comprises (i) a water inlet on the second side of the lid, (ii) a drainage conduit formed at a predefined acute angle (e.g. between five and forty degrees, between 8 and 25 degrees, etc.) with a plane defined by the rim of the lid, and (iii) a water egress area formed on a perimeter side-wall surface of the lid near the second side of the lid. The drainage channel is configured to prevent contact of water with the electronic components. In some embodiments, one or more of external fluid (e.g., water from rainfall), insect matter, and particulate matter (e.g., dust particles) entering the portable solar powered light at the water inlet are directed to flow along the drainage conduit at the predefined acute angle and exit the portable solar powered light at the water egress area without making contact with the electronic components, thereby providing robustness to external environmental factors (such as rain and particulate matter).

### BRIEF DESCRIPTION OF THE DRAWINGS

FIG. 1 is a first perspective view of a portable solar powered light, in accordance with some embodiments.

FIG. 2A is a front view of the portable solar powered light, in accordance with some embodiments.

FIG. 2B is a rear view of the portable solar powered light, in accordance with some embodiments.

FIG. 3 is a side view of the portable solar powered light, in accordance with some embodiments.

FIG. 4 is a side view of the portable solar powered light illustrating locking positions for a rotatable handle attached to a lid of the portable solar powered light, in accordance with some embodiments.

FIGS. 5-8 are side views of the portable solar powered light illustrating a light source shining light into a receptacle light shade of the portable solar powered light, in accordance with some embodiments.

FIGS. 9-11 include cross-sectional views of a lid of the portable solar powered light illustrating a drainage channel encased in the lid, in accordance with some embodiments.

FIG. 12 illustrates a printed circuit board fitted in the lid including electronic components, in accordance with some embodiments.

Like reference numerals refer to corresponding parts throughout the drawings.

### DESCRIPTION OF EMBODIMENTS

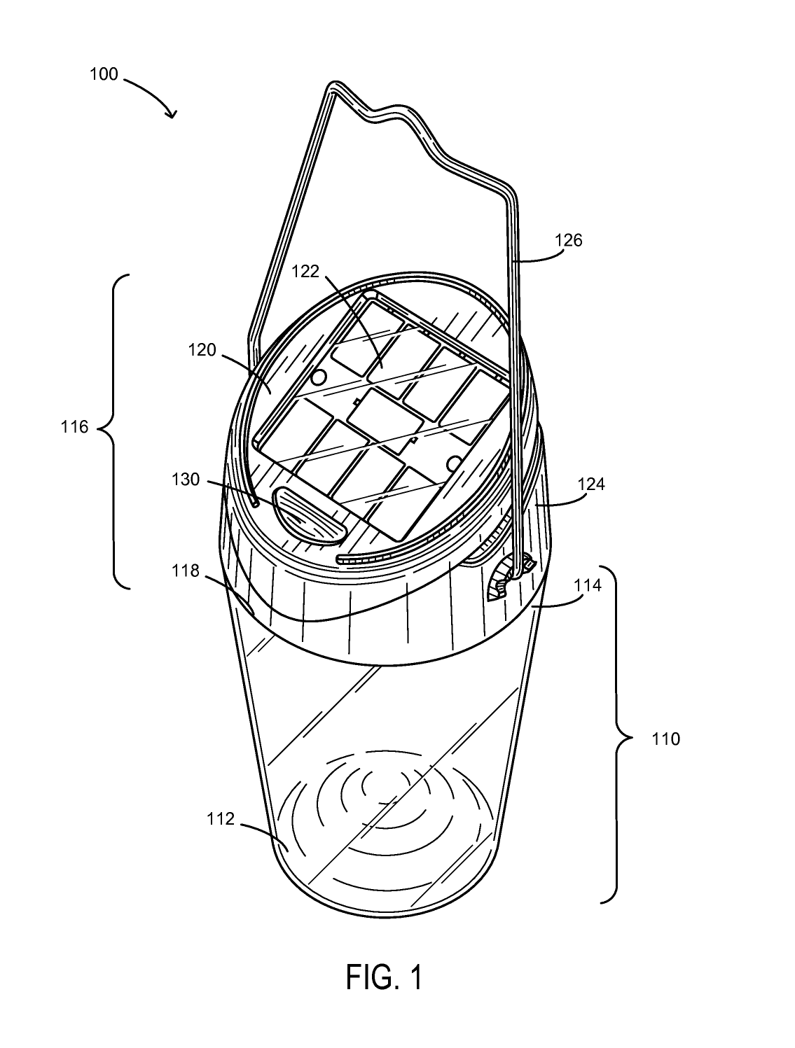

FIG. 1 illustrates a first perspective view of a portable solar powered light 100, in accordance with some embodiments. In some embodiments, portable solar powered light 100 has a weight between 140 grams and 450 grams. In some embodiments, portable solar powered light 100 has a weight between 250 grams and 350 grams. In embodiments, portable solar powered light 100 has a weight between 200 grams and 400 grams. In some embodiments, portable solar powered light 100 has a width between 5 centimeters and 10 centimeters. In some embodiments, portable solar powered light 100 has a width between 8 centimeters and 9 centimeters. In some embodiments, portable solar powered light 100 has a length between 15 centimeters and 25 centimeters. In some embodiments, portable solar powered light 100 has a length between 18 centimeters and 22 centimeters. As shown in FIG. 1, portable solar power light 100 comprises receptacle light shade 110 and lid 116.

Receptacle light shade 110 has a shape characterized by a frustum of a right circular cone having a hollow interior, or an approximation of a frustum of a right circular cone, with closed end 112 and open end 114. Open end 114 of the receptacle light shade 110 is larger than closed end 112. For instance, in some embodiments, open end 114 has a greater perimeter than closed end 112. Furthermore, it will be appreciated that open end 114 is sealed when the portable solar powered light 100 is fully assembled and is only truly “open” when the light 100 is in the unassembled state.

Lid 116 has first side 118 and second side 120. Lid 116 further includes a perimeter side-wall surface 124 (e.g., forming a side wall). First side 118 includes a rim (not shown) that defines the boundary of an interior portion of lid 116. The rim of lid 116 is configured to twistingly interlock (e.g., using mating sets of grooves or threads) with open end 114 of receptacle light shade 110 thereby sealing the hollow interior of receptacle light shade 110. Second side 120 of lid 116 opposes first side 118. Portable solar power light 100 further includes solar panel 122 embedded in second side 120 of lid 116. In some embodiments, solar panel 122 includes a photovoltaic having a thin-film semiconductor junction based upon copper indium diselenide or other type I-III-VI material. In some embodiments, solar panel 122 includes a photovoltaic having a junction based upon crystalline silicon, amorphous silicon, or polycrystalline silicon. In some embodiments, solar panel 122 includes a photovoltaic having a semiconductor junction based upon cadmium telluride or other type II-VI materials.

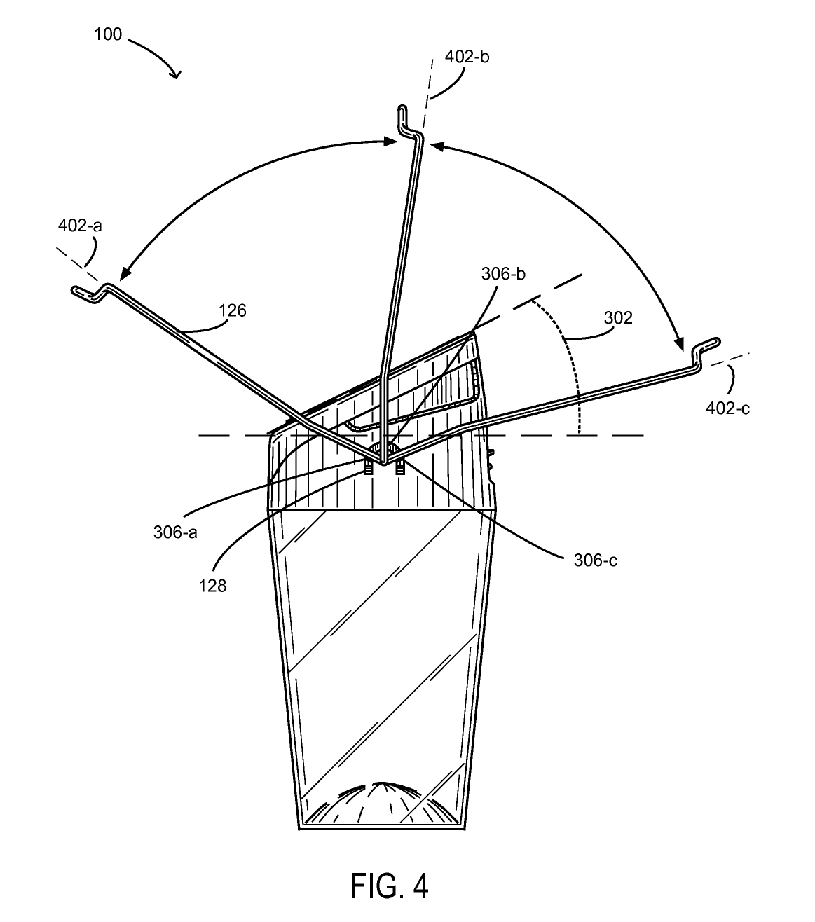

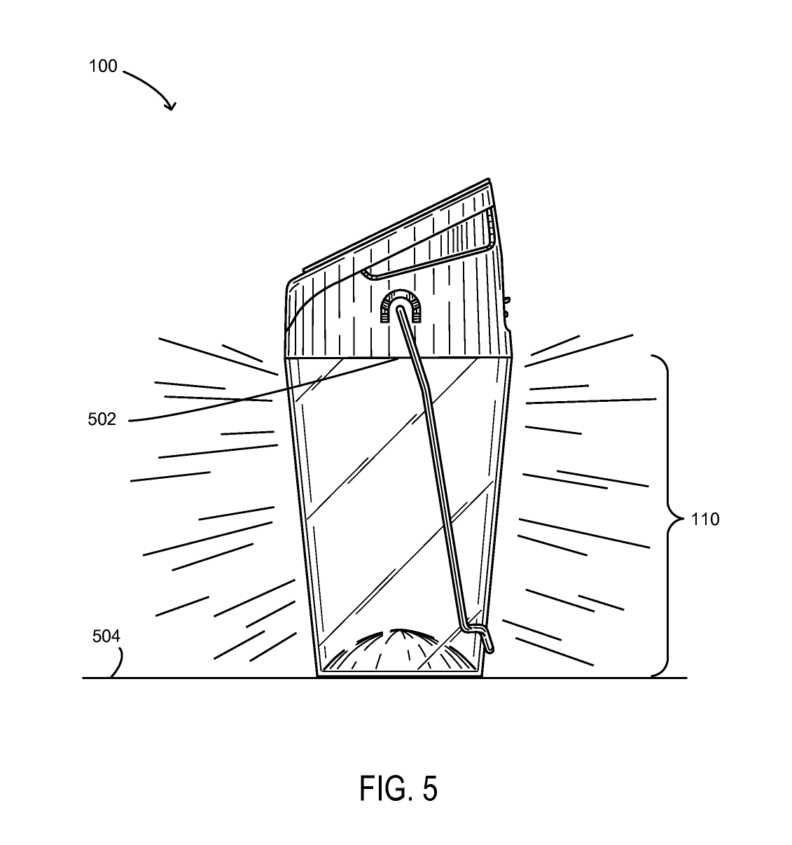

In some embodiments, portable solar powered light 100 includes rotatable handle 126 (explained further with respect to FIG. 4). In some embodiments, the rotatable handle 126 is made of plastic, aluminum, or steel. In some embodiments, portable solar powered light 100 includes push-button switch 130 formed, for example, on second side 120 of lid 116. In such embodiments, push-button switch 130 is configured to actuate a light source (e.g., light source 502 described with reference to FIG. 5 below). In some embodiments, push-button switch 130 is formed of a water-resistant material.

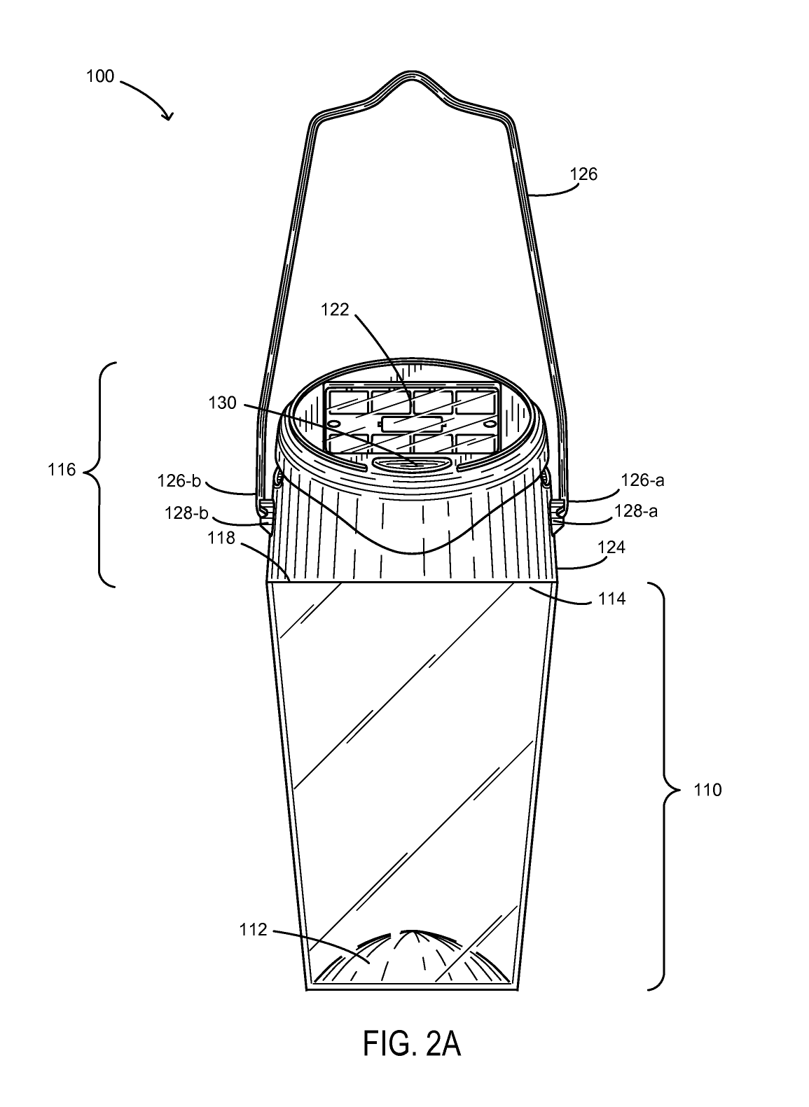

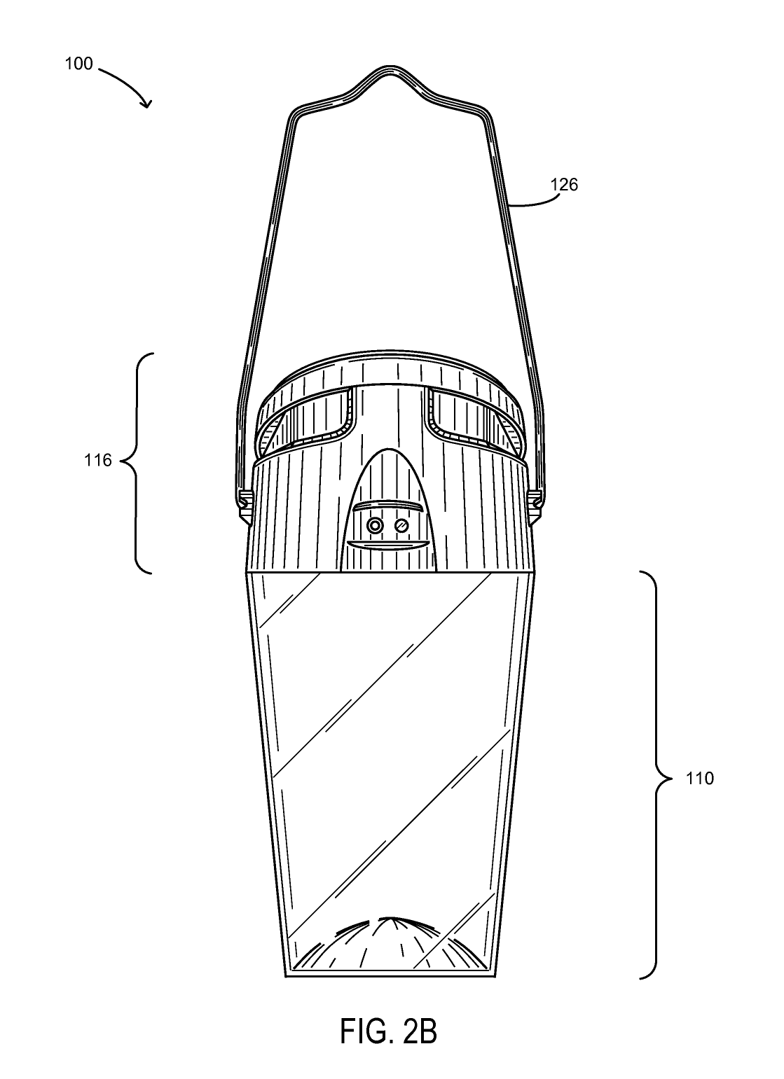

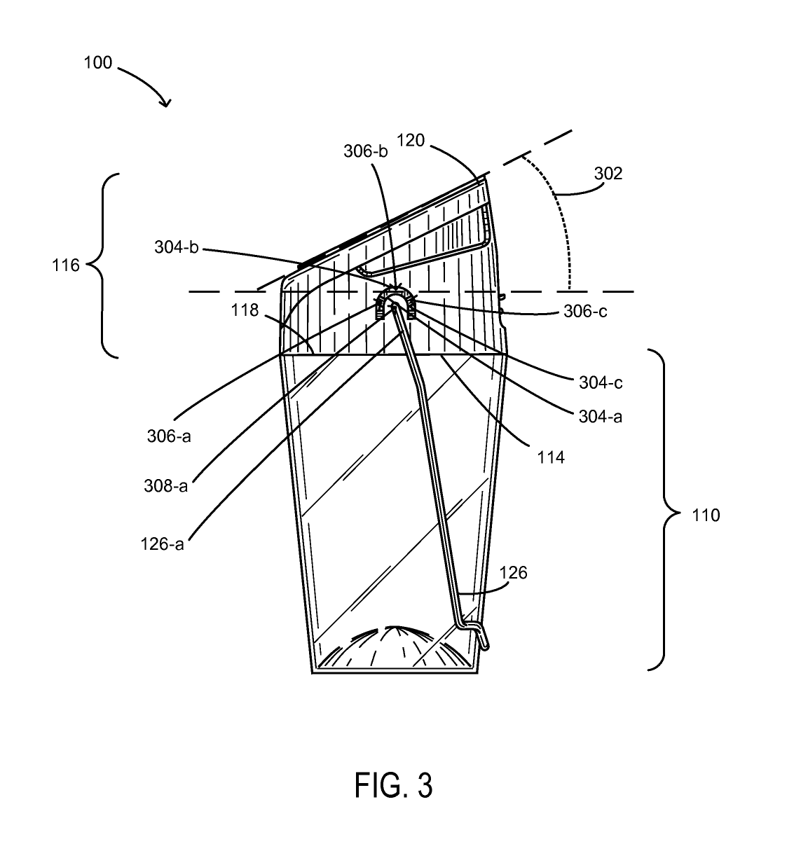

FIG. 2A is a front view of portable solar powered light 100, in accordance with some embodiments. As shown in FIG. 2A, in some embodiments, portable solar powered light 100 includes rotatable handle 126 having first end 126-a and second end 126-b. First end 126-a is coupled to a first joint (e.g., joint 308-a, FIG. 3) on perimeter side-wall surface 124 of lid 116 and second end 126-b is coupled to a second joint on perimeter side-wall surface 124. The first joint is diametrically opposed to the first second joint. In some embodiments, portable solar powered light 100 includes first curved embankment 128-a formed on perimeter side-wall surface 124 of lid 116 near the first joint. In some embodiments, portable solar powered light 100 includes second curved embankment 128-b formed on perimeter side-wall surface 124 of lid 116 near the second joint.

FIG. 2B is a rear view of portable solar powered light 100, in accordance with some embodiments.

FIG. 3 is a side view of the portable solar powered light, in accordance with some embodiments. As shown in FIG. 3, second (top) side 120 of lid 116 opposes first (bottom) side 118 of lid 116 and is configured to form first predefined acute angle 302 with a plane defined by open end 114 of receptacle light shade 110 when the rim of lid 116 is interlocked with open end 114 of receptacle light shade 110. In some embodiments this acute angle is between 1 and 60 degrees. In some embodiments this acute angle is between 3 and 55 degrees. In some embodiments this acute angle is between 5 and 50 degrees. In some embodiments this acute angle is between 7 and 50 degrees. In some embodiments this acute angle is between 9 and 50 degrees. In some embodiments this acute angle is between 11 and 50 degrees. In some embodiments this acute angle is between 13 and 45 degrees. In some embodiments this acute angle is between 15 and 40 degrees.

As explained with reference to FIG. 2A, in some embodiments, portable solar powered light 100 includes rotatable handle 126 having first end 126-a and second end 126-b; first end 126-a being coupled to a first joint (e.g., joint 308-a, FIG. 3) on perimeter side-wall surface 124 of lid 116, and second end 126-b being coupled to a second joint on perimeter side-wall surface 124. Additionally, in some embodiments, portable solar powered light 100 includes first curved embankment 128-a formed on perimeter side-wall surface 124 of lid 116 near the first joint and second curved embankment 128-b formed on perimeter side-wall surface 124 of lid 116 near the second joint. Referring collectively to FIGS. 2A and 3, in some embodiments, first curved embankment 128-a and second curved embankment 128-b (FIG. 2A) each comprise a first concave surface 304-a (FIG. 3) opening to (facing) first side 118 of lid 116 and positioned around the corresponding joint (e.g., first curved embankment 128-a surrounds joint 308-a), a second convex surface 304-b (FIG. 3) facing second side 120 of lid 116 and away from the corresponding joint, and outer surface 304-c orthogonal to and bounding corresponding first concave surface 304-a and second convex surface 304-b. Outer surface 304-c is raised from the perimeter side-wall surface 124. In some embodiments outer surface 304-c is raised from the perimeter side-wall surface 124 by more than 1 millimeter, more than 2 millimeters, more than 3 millimeters, more than 5 millimeters, more than 10 millimeters, more than 20 millimeters, more than 100 millimeters, or more than 500 millimeters.

Referring to FIG. 2A, in some embodiments, first curved embankment 128-a and second curved embankment 128-b are configured to allow a sliding rotation of handle 126 over the corresponding outer surface (e.g., outer surface 304-c) and to direct water flowing toward the embankment, on a surface of handle 126, along the second convex surface (e.g., second convex surface 304-b) thereby away from the corresponding joint (e.g., joint 308-a). In some embodiments, the curved embankments 128 each include a plurality of recesses (notches) 306 (e.g., recesses 306-a, 306-b, and 306-c) that are in register with each other and therefore are able to lock handle 126 in any one of several different positions, as explained further below with reference to FIG. 4.

FIG. 4 is a side view of the portable solar powered light illustrating locking positions for a rotatable handle attached to a lid of the portable solar powered light, in accordance with some embodiments. As shown in FIG. 4, in some embodiments, the first curved embankment (e.g., first curved embankment 128-a, FIG. 2A) and the second curved embankment (e.g., second curved embankment 128-b, FIG. 2B) each include a matching plurality of recesses (e.g., recesses 306-a, 306-b, and 306-c, also described with reference to FIG. 3) that are configured to lock rotatable handle 126 in one of a plurality of discrete corresponding positions (e.g., a plurality of discrete positions 402, such as position 402-a, 402-b, and 402-c corresponding to recesses 306-a, 306-b, and 306-c respectively). In some embodiments, the matching plurality of corresponding recesses on the first curved embankment (e.g., first curved embankment 128-a, FIG. 2A) and the second curved embankment (e.g., second curved embankment 128-b, FIG. 2B) each include a recess (e.g., recess 306-b) that is configured to lock rotatable handle 126 in a plane substantially orthogonal to the plane defined by the rim of lid 116 (e.g., in position 402-b). In some embodiments each curved embankment includes two or more recesses 306, three or more recesses 306, four or more recesses 306, or five or more recesses 306.

FIGS. 5-8 are side views of portable solar powered light 100 illustrating light source 502 shining light into receptacle light shade 110 of the portable solar powered light 100, in accordance with some embodiments. As shown in FIGS. 5-8, receptacle light shade 110 is directly illuminated by the light source (e.g., without the need for optical lenses, diffusing media and/or optical reflectors) and receptacle light shade 110 transmits the incident light to the surrounding, thereby acting as a distributed source of light. In some embodiments, light source 502 has a power rating between 3 watts and 5 watts. In some embodiments, light source 502 has a power rating between 1 watt and 3 watts. In some embodiments, light source 502 has a power rating between 1 watt and 5 watts.

Accordingly, in some embodiments, light source 502 is configured to directly couple light into receptacle light shade 110 and receptacle light shade 110 is formed of a homogenous light transmitting material. In some embodiments, receptacle light shade 110 is made of a transparent plastic or glass. In some embodiments, push-button switch 130 (FIG. 1) formed, for example, on second side 120 (FIG. 1) of lid 116 is configured to actuate light source 502. In some embodiments, push-button switch 130 is further configured to control an intensity of light emitted by light source 502. For instance, in one embodiment, pushing switch 130 once powers a low intensity light from light source 502, pushing switch 130 a second time powers a higher intensity light from light source 502, and pushing switch 130 a third time powers off the light from light source 502. In some embodiments, push-button switch 130 is further configured to emanate light when a level of ambient light is below a predefined threshold. For example, push-button switch 130 is configured to glow (e.g., fluoresce) in the absence of ambient light (e.g., in the dark).

FIG. 5 illustrates portable solar powered light source 100 placed on a rim that defines the boundary of closed end 112 of receptacle light shade 110, for example, on a flat horizontal surface 504.

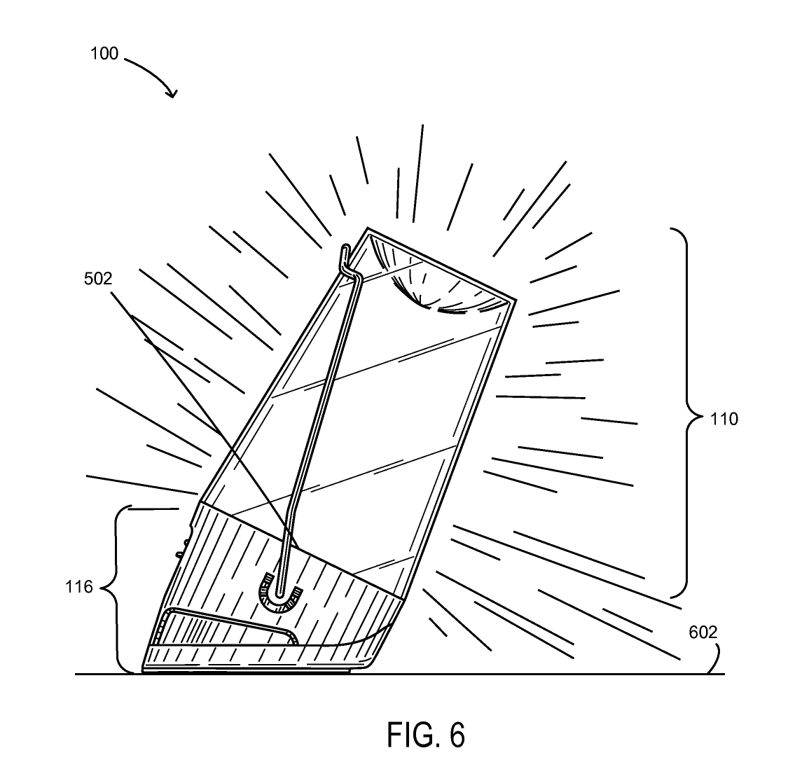

FIG. 6 illustrates portable light source 100 placed on second side 120 (FIG. 1) of lid 116, for example, on a flat horizontal surface 602. In this way, the light source can provide ambient light to a room or area without any requirement that the light be suspended from above.

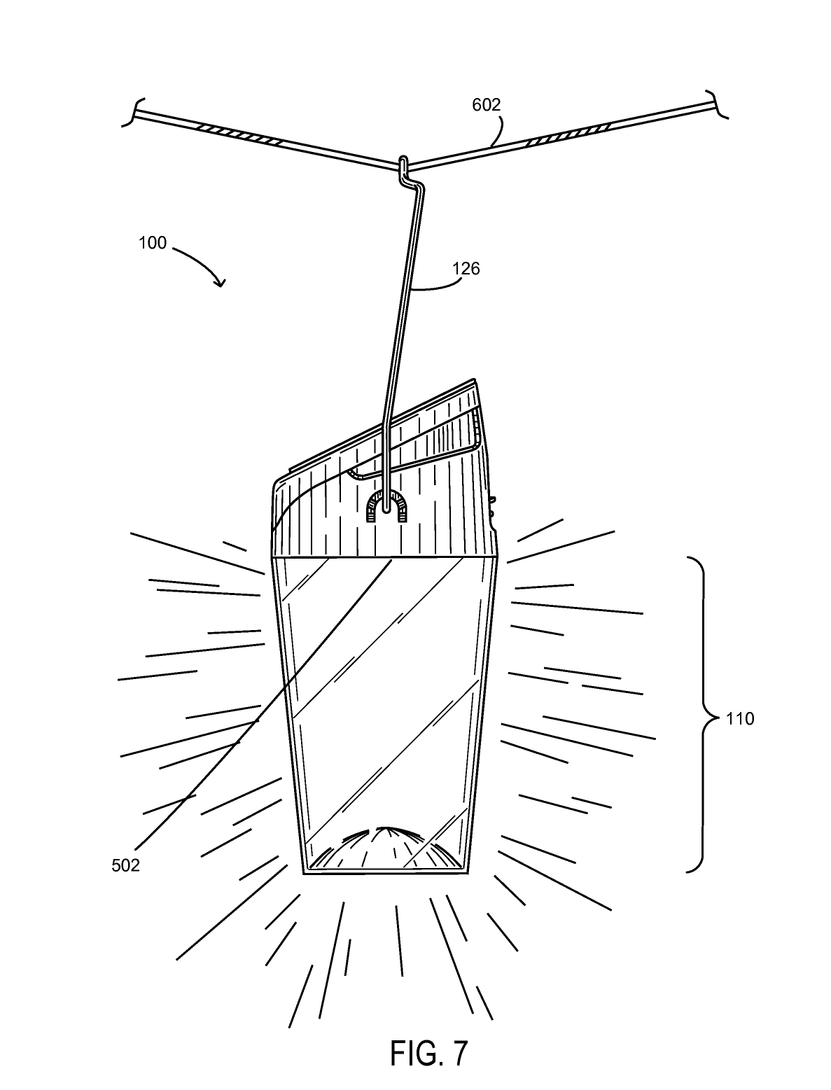

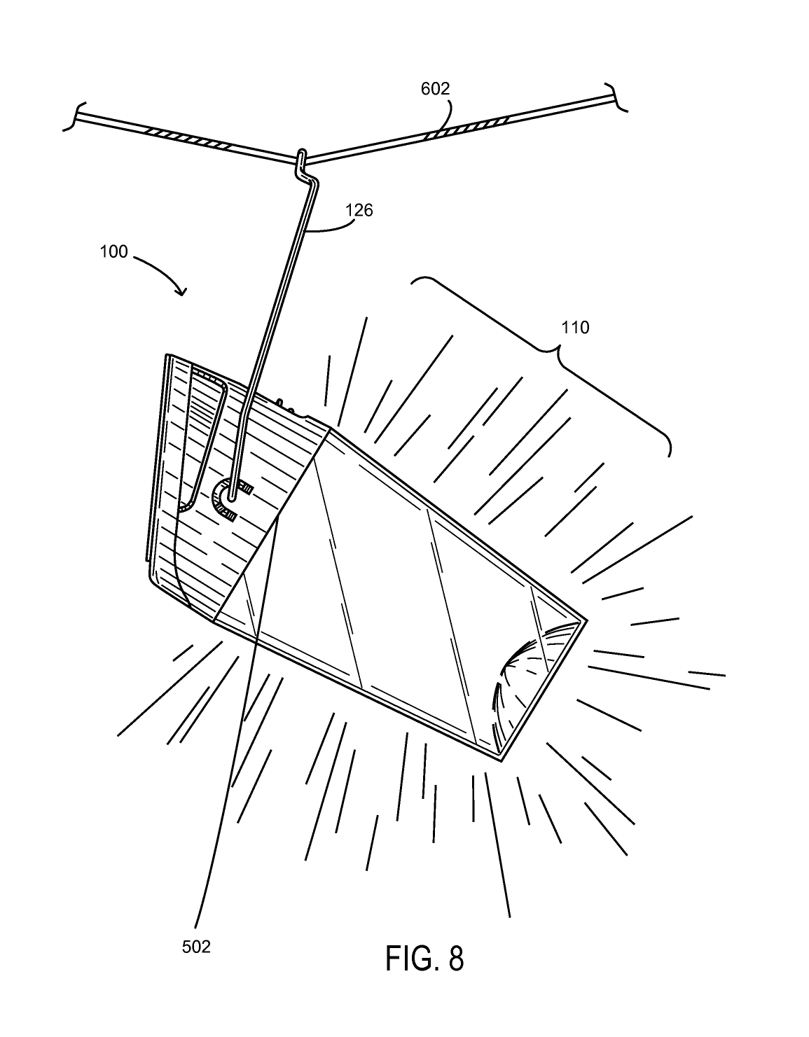

FIGS. 7-8 illustrate portable solar powered light source 100 suspended from suspension means 602 (e.g., elastic thread, inelastic rope, protruding nail, hook or the like) by rotatable handle 126 locked in one of the plurality of discrete positions 402 (as described with reference to FIG. 4) into a matching plurality of recesses 306 (FIG. 3) present along first curved embankment 128-a (FIG. 2A) and second curved embankment 128-b (FIG. 2A) formed on perimeter side-wall surface 124 (FIG. 1) of lid 116. In this way, the light source can provide ambient light to a room or area from above.

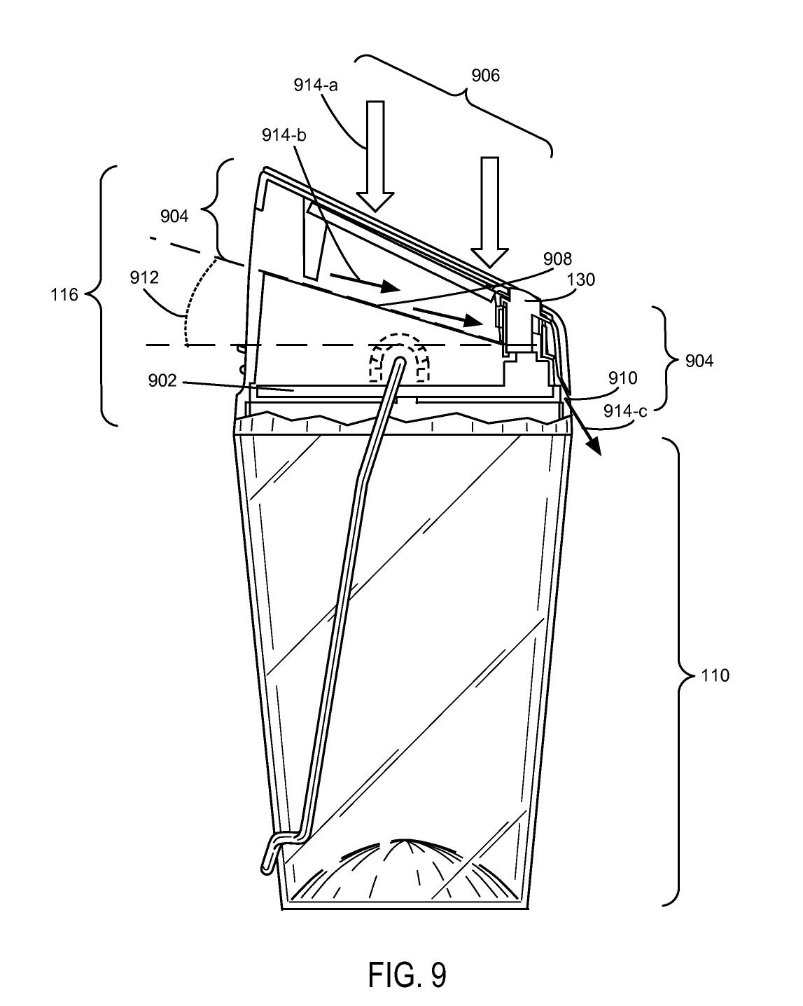

FIGS. 9-11 include cross-sectional views of lid 116 of portable solar powered light 100 illustrating drainage channel 904 encased in lid 116, in accordance with some embodiments.

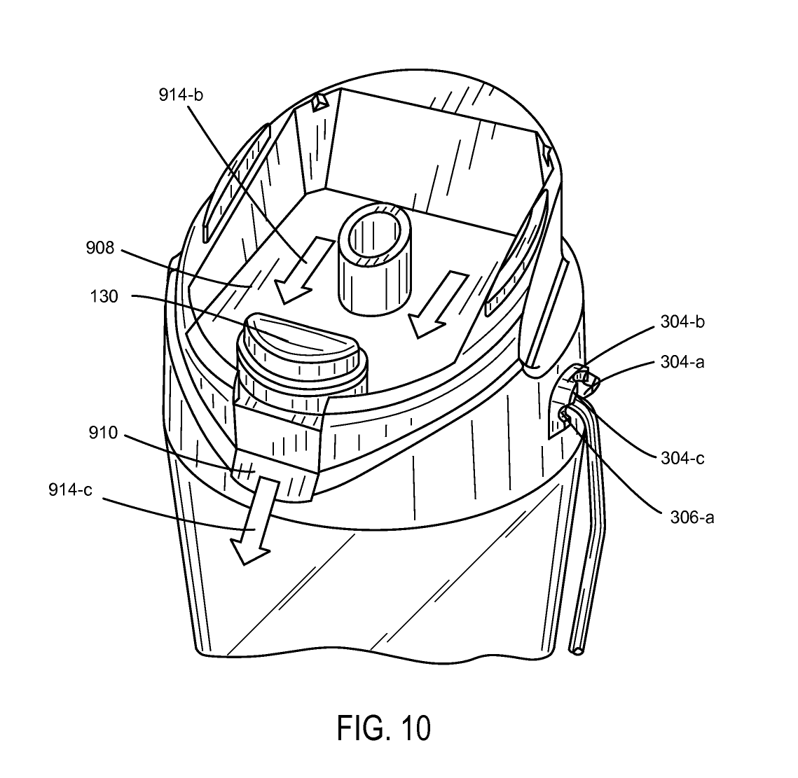

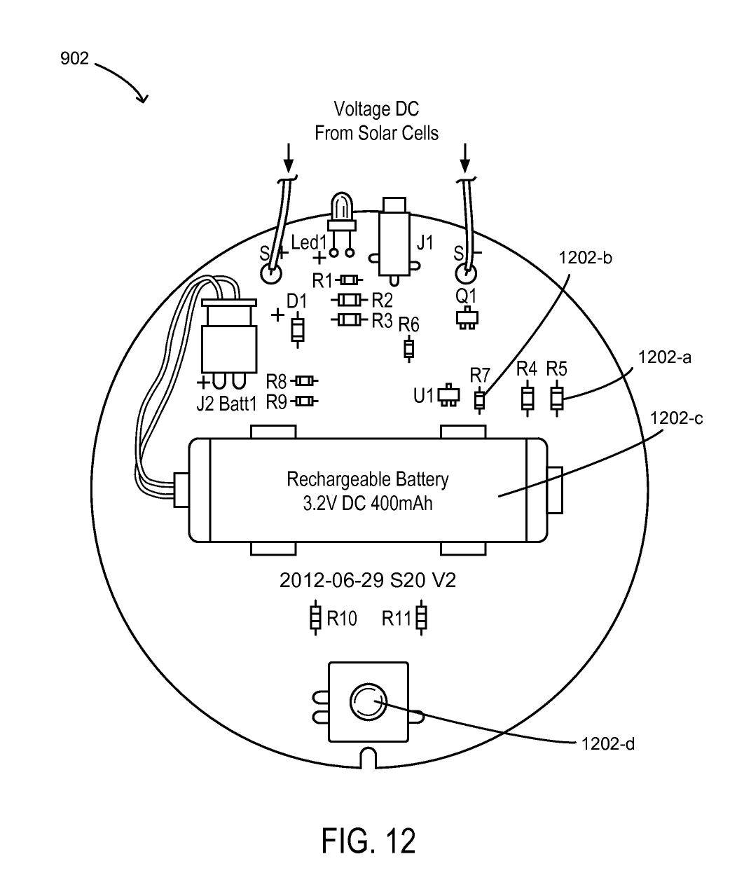

As shown in FIGS. 9-10, portable solar powered light 100 comprises drainage channel 904 encased in lid 116. Drainage channel 904 comprises water inlet 906 on second side 120 (FIG. 1) of lid 116. Drainage channel 904 further comprises drainage conduit 908 formed at second predefined acute angle 912 with a plane defined by the rim of lid 116. Drainage channel 904 comprises water egress area 910 formed on perimeter side-wall surface 124 (FIG. 1) of lid 116 proximate second side 120 of lid 116. Drainage channel 904 is configured to prevent contact of water with a plurality of electronic components (e.g., a plurality of electronic components attached to a side of circuit board 902, as explained further with reference to FIG. 12). In some embodiments, one or more of external fluid, insect matter, and particulate matter (e.g., air-borne particles, such as dust) entering (914-a) portable solar powered light 100 at water inlet 906 is directed to flow (914-b) along drainage conduit 908 at second predefined acute angle 912 and exit (914-c) portable solar powered light 100 at water egress area 910 without making contact with the plurality of electronic components.

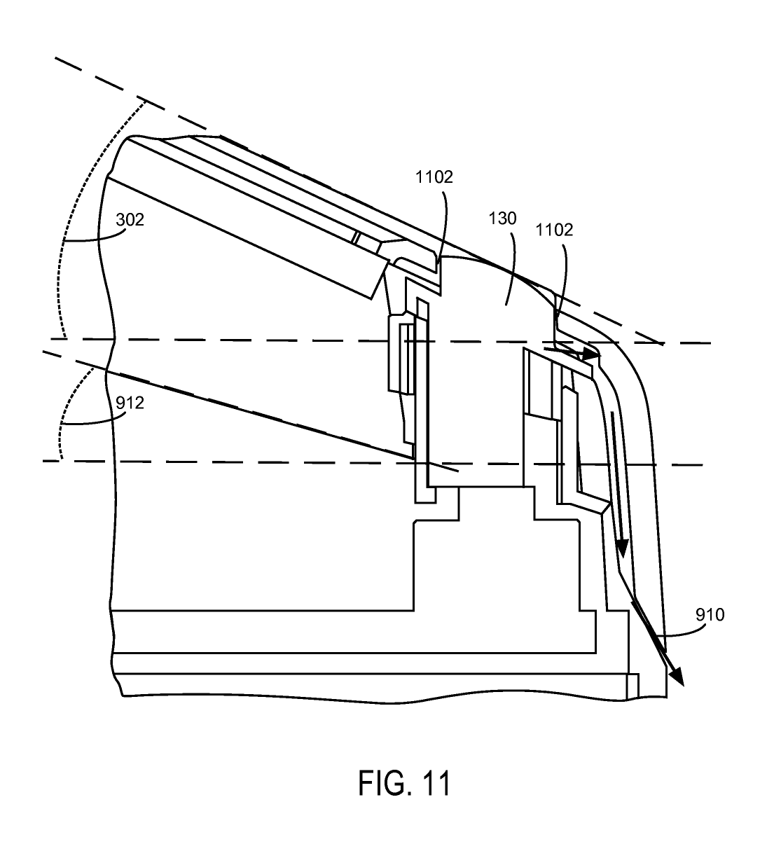

As shown in FIG. 11, in some embodiments, push-button switch 130 includes a water-resistant cover configured to direct one or more of external fluid, insect matter, and particulate matter entering lid 116 on second side 120 (FIG. 1) at crevice 1102 surrounding push-button switch 130 toward water egress area 910.

As such, the inclusion of drainage channel 904 in lid 116 and the water resistant design of push-button switch 130 provides robustness against external environmental factors (such as water from rainfall and particulate matter).

FIG. 12 illustrates printed circuit board 902 fitted in lid 116 (e.g., as shown in FIG. 1) including a plurality of electronic components 1202, in accordance with some embodiments.

As shown in FIG. 12, printed circuit board 902 is fitted within the interior portion of lid 116 (FIG. 1). Printed circuit board 902 includes a plurality of electronic components 1202 (e.g., electronic components 1202-a, 1202-b, 1202-c, 1202-d, and the like) attached to a first side of circuit board 902 facing into the interior portion of lid 116. Printed circuit board 902 further includes a light source (e.g., light source 502, FIGS. 5-8) directly attached to a second side of circuit board 902 that opposes the first side of circuit board 902 so that the light source e.g., light source 502, FIGS. 5-8) is proximal to receptacle light shade 110 (FIGS. 5-9) and is configured to shine light into receptacle light shade 110 (as explained with reference to FIGS. 5-9), the plurality of electronic components 1202 in electronic communication (e.g., electrically connected by means of traces and/or vias) with the light source and configured to power the light source.

Furthermore, a solar panel (e.g., solar panel 122 embedded in second side 120 of lid 116, FIG. 1) is configured to be in electronic communication (e.g., electrically connected by means of traces and/or vias) with and powering the plurality of electronic components 1202. In some embodiments, the plurality of electronic components 1202 include one or more energy storage devices (e.g., rechargeable battery 1202-c) configured to store energy obtained from solar panel 122 (FIG. 1) or an alternating current source and further configured to power one or more of the plurality of electronic components (e.g., one or more of electronic components 1202-a, 1202-b, 1202-c, and the like) and the light source (e.g., light source 502, FIG. 5). Accordingly, portable solar powered light 100 is configured to be self-powered or powered by natural solar energy and provide sustainable light in the absence of electric power.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A portable solar powered light comprising:
a receptacle light shade, the receptacle light shade having a shape characterized by a frustum of a right circular cone having a hollow interior, or an approximation of a frustum of a right circular cone, with a closed end and an open end, wherein the open end is larger than the closed end;
a lid having a first side and a second side, the first side including a rim that defines the boundary of an interior portion of the lid, the rim configured to twistingly interlock with the open end of the receptacle light shade thereby sealing the hollow interior of receptacle light shade, the second side opposing the first side and configured to form a first predefined acute angle with a plane defined by the open end when the rim is interlocked with the open end of the receptacle light shade;
a printed circuit board fitted within the interior portion of the lid, the printed circuit board including (i) a plurality of electronic components attached to a first side of the circuit board facing into the interior portion of the lid and (ii) a light source directly attached to a second side of the circuit board that opposes the first side of the circuit board so that the light source is proximal to the receptacle light shade and is configured to shine light into the receptacle light shade, the plurality of electronic components in electronic communication with the light source and configured to power the light source;
a solar panel embedded in the second side of the lid, the solar panel in electronic communication with and powering the plurality of electronic components;
a drainage channel encased in the lid, the drainage channel comprising (i) a water inlet on the second side of the lid, (ii) a drainage conduit formed at a second predefined acute angle with a plane defined by the rim of the lid, and (iii) a water egress area formed on a perimeter side-wall surface of the lid proximate the second side of the lid;
wherein the drainage channel is configured to prevent contact of water with the plurality of electronic components.

2. The portable solar powered light of claim 1, wherein the light source is configured to directly couple light into the receptacle light shade and the receptacle light shade is formed of a homogenous light transmitting material.

3. The portable solar powered light of claim 1, wherein one or more of external fluid, insect matter, and particulate matter entering the portable solar powered light at the water inlet are directed to flow along the drainage conduit at the second predefined acute angle and exit the portable solar powered light at the water egress area without making contact with the plurality of electronic components.

4. The portable solar powered light of claim 1, further comprising:
a rotatable handle having a first end and a second end, wherein the first end is coupled to a first joint on the perimeter side-wall surface of the lid and the second end is coupled to a second joint on the perimeter side-wall surface, wherein the first joint is diametrically opposed to the first second joint;
a first curved embankment formed on the perimeter side-wall surface of the lid near the first joint; and
a second curved embankment formed on the perimeter side-wall surface of the lid near the second joint;
wherein the first curved embankment and the second curved embankment each have a first concave surface facing the first side of the lid and surrounding the corresponding joint, a second convex surface facing the second side of the lid and away from the corresponding joint, and an outer surface orthogonal to and bounding the corresponding first concave surface and the second convex surface;
wherein the first curved embankment and the second curved embankment are configured to allow a sliding rotation of the handle over the corresponding outer surface and to direct water flowing toward the embankment, on a surface of the handle, along the second convex surface thereby away from the corresponding joint.

5. The portable solar powered light of claim 4, wherein the first curved embankment and the second curved embankment each include a matching plurality of recesses that are configured to lock the rotatable handle in one of a plurality of discrete corresponding positions.

6. The portable solar powered light of claim 5, wherein the matching plurality of corresponding recesses on the first curved embankment and the second curved embankment each include a recess that is configured to lock the rotatable handle in a plane substantially orthogonal to the plane defined by the rim of the lid.

7. The portable solar powered light of claim 1, wherein the plurality of electronic components include one or more energy storage devices configured to store energy obtained from the solar panel or an alternating current source and further configured to power one or more of the plurality of electronic components and the light source.

8. The portable solar powered light of claim 1, further comprising a push-button switch formed on the second side of the lid, the push-button switch configured to actuate the light source.

9. The portable solar powered light of claim 8, wherein the push-button switch is formed of a water-resistant material.

10. The portable solar powered light of claim 9, wherein the push-button switch includes a water-resistant cover configured to direct one or more of external fluid, insect matter, and particulate matter entering the lid on the second side at a crevice surrounding the push-button switch toward the water egress area.

11. The portable solar powered light of claim 8, wherein the push-button switch is further configured to control an intensity of light emitted by the light source.

12. The portable solar powered light of claim 8, wherein the push-button switch is further configured to emanate light when a level of ambient light is below a predefined threshold.

13. The portable solar powered light of claim 1, wherein the receptacle light shade is made of a transparent plastic.
